(19) United States
(12) Patent Application Publication
(10) Pub. No.: US 2011/0283276 A1
(43) Pub. Date: Nov. 17, 2011

(54) System and Method for Automated Information Handling System Network Device Discovery and Support

(76) Inventors: Carlton Andrews, Austin, TX (US); Yuan-Chang Lo, Austin, TX (US)

(21) Appl. No.: 12/777,634

(22) Filed: May 11, 2010

(51) Int. Cl. G06F 9/445; G06F 15/177

(52) U.S. Cl. 717/177; 709/220

(57) ABSTRACT

Extended network plug and play functionality is provided for a first network device with a proxy located at a second network device. The proxy advertises a profile for the first network device and responds to a query of the profile by a third network device. The proxy provides an install package for the first network device to the third network device that the third network device applies to interact with the first network device through the network. In one embodiment, the proxy automatically detects network devices that are not plug and play compliant and retrieves the profile for the non-compliant network device using an identifier retrieved from the non-compliant device, such as a MAC address.

### BACKGROUND OF THE INVENTION

1. Field of the Invention

The present invention relates in general to the field of information handling system networks, and more particularly to a system and method for automated information handling system network device discovery and support.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One feature of information handling systems that is attractive to both enterprises and individuals is the ability of information handling systems to interact with each other and a wide variety of peripheral devices through direct cable connections or through network interfaces. Often, such interaction is supported by software, such as drivers, that execute on information handling systems to aid communication of information. A difficulty with such software is that an end user sometimes must locate, load and configure the software before an information handling system will interact with a device. In order to simplify this process, the Universal Plug and Play (UPnP) Forum developed a Simple Service Discovery Protocol (SSDP) which calls for a device to advertise available service in an automated discovery process so that an information handling system can automatically identify the device and configure to interact with the device. The Plug-n-Play Extension (PnP-X), a recent extension of UPnP, supports automated network device discovery and device driver services installation, such as I/O device discovery from traditional peripheral bus like PCI, PCIe, USB, etc. . . . , to local area IP networks. PnP-X protocols enable devices, including information handling systems, attached to a common network to automatically discover each other, the capabilities or services of each other, and also allow for extension of the capabilities by allowing a PnP-X capable device to automatically acquire and install drivers, services or applications needed to interact with other devices. For example, a laptop and desktop information handling system interfaced with a network will automatically detect and install a network or shared printer through the network when the printer is brought on line. As another example, the information handling systems will automatically detect and install a backup service and storage location as each are joined to a network.

In order for PnP-X compliant devices to automatically discover each other and interact, each device must implement a device-side protocol to advertise and respond to queries. Legacy devices deployed before adoption of PnP-X or non-enabled devices that have not implemented the PnP-X protocol will not advertise to or discover from other devices. In some instances, extra processing and memory needed to implement PnP-X on a device make the device prohibitively expensive. Cloud based services that present virtual devices hosted in the Internet or an external network cannot respond to LAN based protocols used by PnP-X. For example, a printer that is not compliant with PnP-X requires a non-trivial install of client software on every device that interacts with the printer, such as a manual install accomplished at each device. As another example, a storage backup system that is not PnP-X compliant will need each backed-up device installed with an application and located at the backup device. Even as PnP-X becomes more common, at least some devices will remain non-compliant and thus require manual implementation at a network.

### SUMMARY OF THE INVENTION

Therefore a need has arisen for a system and method which provides automated information handling system network device discovery and support.

In accordance with the present invention, a system and method are provided which substantially reduce the disadvantages and problems associated with previous methods and systems for discovery and implementation of devices at a network. A proxy executing on a network represents an incompatible plug and play extension device to the network as a plug and play extension device and responds to queries directed to the incompatible device. Other network devices configure to interact with the incompatible device with an installation package provided by the proxy.

More specifically, an information handling system built from plural processing components has a network module to interface through a network with network devices, such as other information handling systems, printers, or backup storage devices. A proxy module executing on the information handling system, such as on the network module or within an operating system, detects network devices that are not plug and play extension compliant and represents the noncompliant network devices on the network. For example, the proxy module retrieves a profile for the noncompliant device from a manufacturer network resource by reference to the MAC address of the noncompliant device and advertises the profiles to the network. Other network devices that query the profiles retrieve the profiles from the proxy module, including an installation package for the noncompliant device. The network devices execute the installation package to automatically configure for network interaction with the noncompliant network device.

The present invention provides a number of important technical advantages. One example of an important technical advantage is that network devices have automated discovery and implementation even where the network device lacks processing or memory capabilities for support PnP-X protocols. For example, the cost of a device deployed to a network is reduced by limiting memory needed to store software that would otherwise be needed for delivery to comply with PnP-X discovery protocols. As another example, the cost of devices is reduced by limiting processing capability at the device that would otherwise be needed to execute the PnP-X advertising and discovery protocols. In addition, legacy devices already deployed to a network are supported so that the legacy devices effectively interact with PnP-X compliant devices subsequently interfaced with the network. A single proxy executing on an existing network device supports PnP-X interactivity for multiple non-compliant devices, thus reducing network complexity and cost.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a plug and play proxy for noncompliant network devices;

FIG. 2 depicts a flow diagram of network device discovery through a plug and play proxy; and

FIG. 3 depicts a flow diagram of discovery of a virtual device though a plug and play proxy.

### DETAILED DESCRIPTION

A proxy running on an information handling system provides plug and play functionality for network devices that are not network plug and play compliant. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

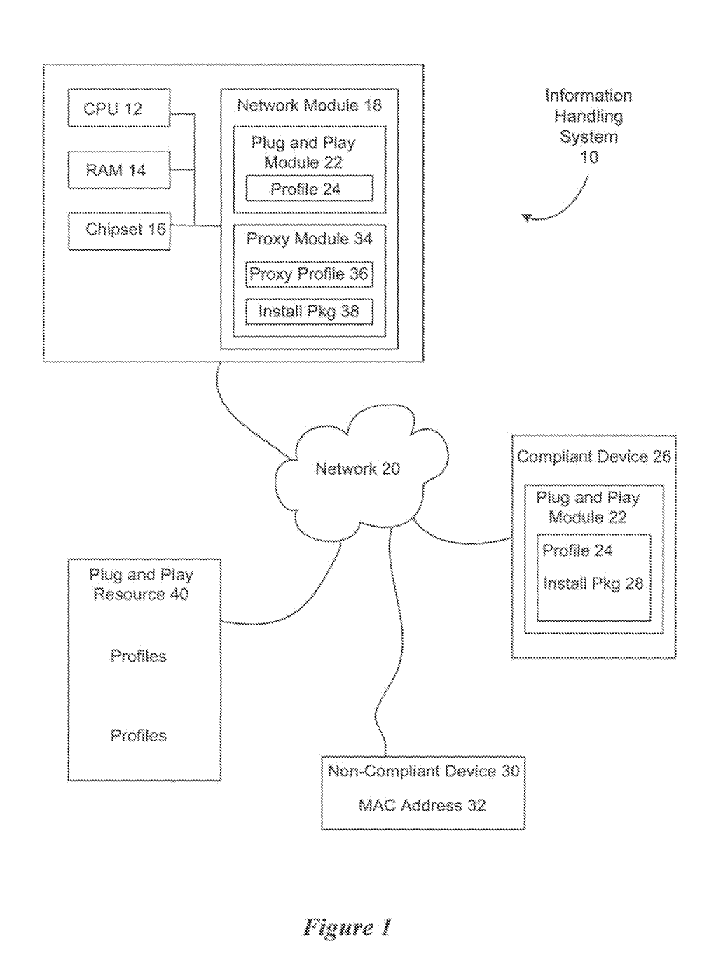

Referring now to FIG. 1, a block diagram depicts an information handling system 10 having a plug and play proxy for noncompliant network devices. Information handling system 10 is built from plural processing components that cooperate to process information, such as a CPU 12, RAM 14, chipset 16 and a network module 18. Network module 18 provides communication of information with a network 20, such as with a network interface card (NIC). A plug and play module 22 associated with network module 18, such as firmware instructions executing on a processor of network module 18, provides network plug and play functionality compliant with the PnP-X standard. For example, plug and play module 22 advertises a profile 24 to network 20 that other plug and play modules detect and query. Plug and play modules respond to advertising queries with information that enables automatic configuration of their associated network devices to communicate with each other. Some example scenarios include information handling system 10 detecting a plug and play module 22 on a compliant device 26, such as network printer or network storage for performing backups. Plug and play module 22 of information handling system 10 queries plug and play module 22 of compliant device 26 through network 20 to request a profile 24. Profile 24 of compliant device 26 includes an install package 28 that is provided to information handling system 10 in response to the query. Information handling system 10 executes the install package to automatically configure itself to use compliant device 26, such as for printing documents through network 20 or performing automated network backups.

In some instances, network devices are non-compliant with PnP-X, such as legacy devices put in use before adoption of PnP-X or simple devices that lack processing and memory resources to support auto-discovery and auto-install functions defined by PnP-X. A non-compliant device 30 interfaces with network 20 using a unique address, such as MAC address 32 and/or an IP address, however does not have a profile to advertise or provide to other network devices. A proxy module 34 running on information handling system 10 detects non-compliant device 30 and provides PnP-X functionality for non-compliant device 30. Proxy module 34 delivers software, services and drivers on behalf of non-compliant device 30, and does not act as a re-director of filter. Proxy module 34 acts as an extension to non-compliant device 30 as if adding on to increase the capabilities of non-compliant device 30, such as providing storage, performance, intelligence or other capabilities for the device it is representing as a proxy. These extended capabilities provide resources to deliver software and services according to PnP-X so that non-compliant device 30 effectively advertises and responds to queries to support autoconfiguration of compliant devices 26 to work with non-compliant device 30. Although FIG. 1 depicts proxy module 34 as executing in memory of information handling system 10, other network devices can support proxy module 34, such as desktop, portable or server information handling systems, or access points, routers, gateways, etc. Proxy module 34 should be hosted on a network device that is turned on for most time periods so that proxy services are available when needed.

Proxy module 34 obtains a proxy profile 36 for non-compliant device 30 to advertise on behalf of non-compliant device 30, including where desired a proxy installation package 38, and then advertises proxy profile 36 to network 20. In one embodiment, proxy module 34 detects network devices that do not advertise a PnP-X profile by searching network addresses, such as MAC addresses. When a non-compliant device is detected, proxy module 34 contacts a PnP proxy resource 40 through network 20 to retrieve a profile for the non-compliant device. For example, proxy module 34 analyzes MAC address 32 to determine a manufacturer of non-compliant device 30 and retrieves a profile from a manufacturer network resource. Alternatively, a non-compliant network device profile is manually entered at information handling system 10 through a management console graphical user interface or installed from a removable medium, such as a CD. Once proxy module 34 has proxy profile 36 for non-compliant device 30, proxy module 34 advertise non-compliant device 30 to network 20 as a PnP-X compliant device and responds to queries directed towards the advertising on behalf of non-compliant device 30. Network devices that interface with network 20 will thus be able to use PnP-X compliant functionality to discover, install and interact with non-compliant devices through proxy module 34. For example, a home network client information handling system works with a non-PnP-X printer to provide PnP-X capabilities on behalf of the printer by having a proxy module inform other network devices of the non-compliant device's presence on the network and install software on the network devices so that the network devices can interact directly with the printer. In an alternative embodiment, a proxy module running on a server information handling system works with local or cloud based storage media, such as virtual disk drives, to inform network devices of the availability of backup storage and automatically provide backup software to execute on network devices for backing up to the storage media.

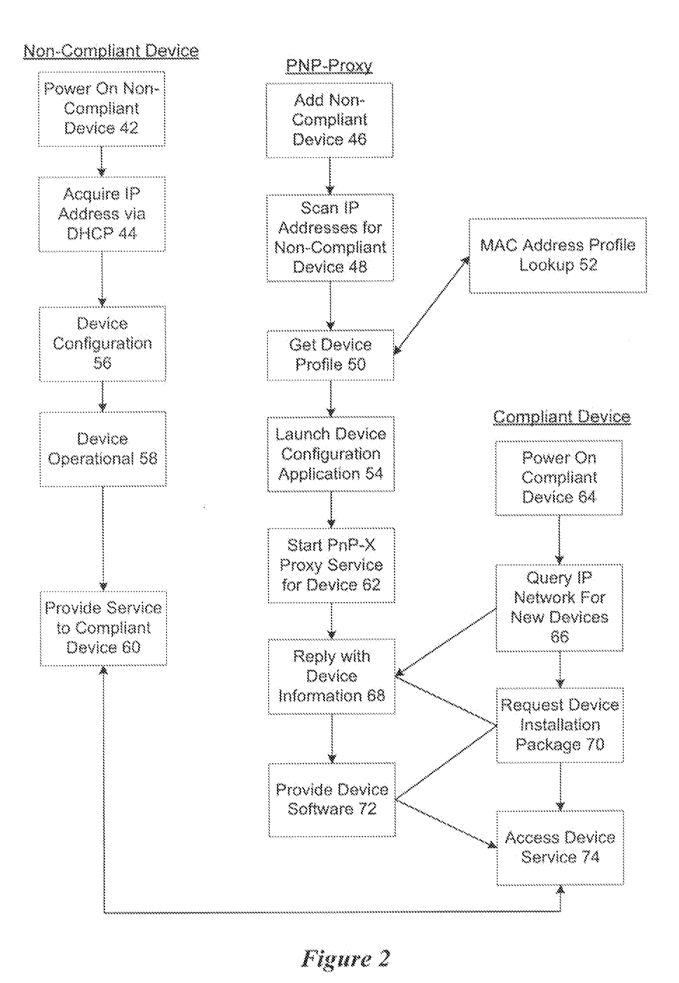

Referring now to FIG. 2, a flow diagram depicts network device discovery through a plug and play proxy. A non-compliant network device powers up at step 42 and acquires an IP address via DHCP at step 44. A proxy module determines to add proxy devices at step 46 and scans IP addresses at step 48 to detect the non-compliant network device. In one embodiment, at step 46 a timer periodically initiates a scan of the network for a new non-compliant device by the proxy module. At step 50, the proxy module gets a device profile for the non-compliant device from a profile lookup resource at step 52, such as by reference to the MAC address of the non-compliant device, for example through a Web-based service provided by the manufacturer of the device. At step 54, the proxy module launches a device configuration application retrieved from the lookup resource to configure the network device at step 56 for interacting with the network in a PnP-X environment. At step 58, the network device becomes operational to provide services at the network. At step 62, the proxy module starts a PnP-X proxy service for the non-compliant network device by advertising the non-compliant network device on the network. At step 64, a network device, such as a client information handling system, powers up at the network and, at step 66, queries the network for new network devices, such as in accordance with the PnP-X standard. At step 68, the proxy module replies to the query with profile for the non-compliant device. At step 70, the network device requests an installation package for the non-compliant device, and, at step 72, the proxy module provides the installation package. At step 74, the network device executes the installation package to access functions provided by the non-compliant device.

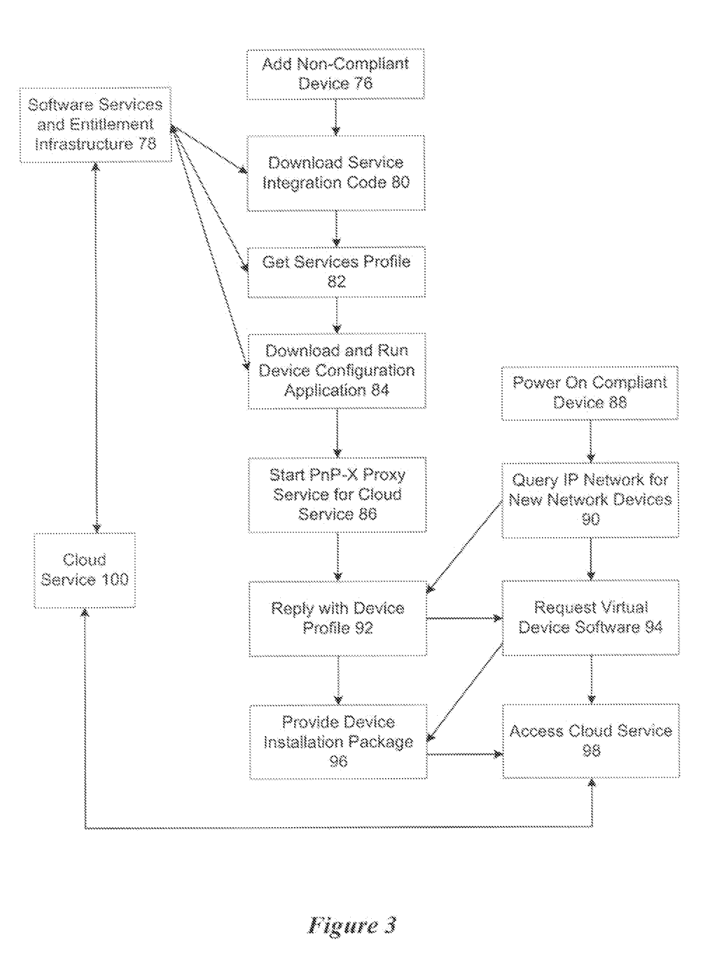

Referring now to FIG. 3, a flow diagram depicts discovery of a virtual device though a plug and play proxy, such as a service provided on a cloud, like storage, or a device in a remote site, like a surveillance camera at a remote site. The process starts at step 76 with adding of a virtual device, such a virtual storage drive, to the network by a proxy module. A software and services entitlement infrastructure at step 78 defines the network's authorization to access the virtual device. At step 80, the proxy module downloads service and integration codes for access to the virtual device. At step 82, the proxy module gets a service profile and at step 84, the proxy module downloads and executes a device configuration application to configure the virtual device for access by the network. At step 86, the proxy module starts PnP-X proxy service for the virtual device by, for instance, advertising the virtual device as a storage drive available to the network. At step 88, a client information handling system or other network device powers up and at step 90 queries the network for new PnP-X devices. At step 92, the proxy module responds with device information for the virtual device. At step 94, the client information handling system requests device software, such as an installation package. At step 96, the proxy module provides the device software, such as an installation package that allows the client information handling system to mount the virtual storage device as a physical drive. At step 98, the client information handling system accesses the cloud-based or remote virtual device 100 to support automated backups, such as with a backup program provided with the installation package or remote services. In alternative embodiments, the virtual device provides other types of virtual services.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process information;
a network module interfaced with the processing components and operable to interface with a network to communicate the information with the network;
a plug and play module associated with the network module, the plug and play module operable to advertise a profile to the network and to detect profiles advertised to the network by other network devices, the plug and play module further operable to provide an install package to devices of the network that respond to the advertised profile and to retrieve an install package from network devices that advertise profiles at the network, the install package having instructions to automatically configure a device that retrieves the install package to interact through the network with the device that provides the install package; and
a proxy module associated with the network module, the proxy module operable to determine that a non-compliant device interfaced with the network lacks a plug and play module, to advertise a profile to the network on behalf of the non-compliant device and to respond to queries of the advertised profile on behalf of the non-compliant device.

2. The information handling system of claim 1 wherein the proxy module responds to queries of the advertised profile on behalf of the non-compliant device by providing an install package to the device making the query of the advertised profile for the non-compliant device.

3. The information handling system of claim 2 wherein the non-compliant device comprises a printer.

4. The information handling system of claim 2 wherein the non-compliant device comprises a virtual storage device.

5. The information handling system of claim 4 wherein the proxy module advertises the virtual storage device as a physical storage device.

6. The information handling system of claim 4 wherein the installation package comprises a backup module operable to execute on a device to automatically backup information of the device to the virtual storage device.

7. The information handling system of claim 1 wherein the proxy module is further operable to determine that a non-compliant device interfaced with the network lacks a plug and play module by detecting a device interfaced with the network, retrieving a unique identifier from the device and retrieving a profile for the non-compliant device from a network location.

8. The information handling system of claim 7 wherein the unique identifier comprises the device MAC address.

9. The information handling system of claim 1 further comprising a removable medium storing the non-compliant device profile for loading onto the processing components.

10. A method for automated network device discovery, the method comprising:
interfacing a first network device with a network;
advertising a profile for the first network device to the network from a second network device;
detecting the profile through the network with a third network device;
querying the second network device with the third network device to retrieve the profile from the second network device to the third network device;
executing an install package included with the profile on the third network device; and
interacting the third network device with the first network device using instructions provided by the install package.

11. The method of claim 10 wherein the first network device comprises a printer.

12. The method of claim 10 wherein the first network device comprises a virtual storage device.

13. The method of claim 12 wherein advertising a profile further comprises advertising the virtual storage device as a physical storage device.

14. The method of claim 10 wherein advertising a profile for a first network device further comprises:
detecting the first network device with the second network device;
determining with the second network device that the first network device lacks the capability to advertise a profile; and
retrieving the profile of the first network device to advertise at the network.

15. The method of claim 14 wherein retrieving further comprises:
retrieving an identifier from the first network device;
using the identifier to locate the profile of the first network device.

16. The method of claim 15 wherein the identifier comprises a MAC address.

17. The method of claim 10 wherein the first network device comprises a storage device and the install package comprises a backup application for backing up information stored at a network device to the storage device.

18. A system for automated network device discovery, the system comprising:
a network module operable to interface with a network; and
a proxy module associated with the network module, the proxy module operable to determine that a first network device interfaced with the network lacks a plug and play module, to advertise a profile to the network on behalf of the first network device and to respond to queries by a second network device of the advertised profile on behalf of the first network device by providing an install package for the first network device to the second network device.

19. The system of claim 18 wherein the first network device comprises a printer and the install package comprises instructions for printing information from the second network device at the printer through the network.

20. The system of claim 18 wherein the first network device comprises storage and the install package comprises instructions for automatically backing up the second network device to the first network device through the network.
